(19) United States
(12) Patent Application Publication
(10) Pub. No.: US 2005/0155874 A1
(43) Pub. Date: Jul. 21, 2005

(54) SMIF box and loading system of reticle

(76) Inventor: Noah Chen, Jhubei City (TW)

Correspondence Address: J C PATENTS, INC., 4 VENTURE, SUITE 250, IRVINE, CA, 92618, US

(21) Appl. No.: 10/762,070

(22) Filed: Jan. 21, 2004

(51) Int. Cl. F17C 11/00

(52) U.S. Cl. 206/204; 206/704

(57) ABSTRACT

A SMIF box for storing a reticle is described, including a base pedestal for holding a reticle and a box cover fitting with the base pedestal. The box cover includes an O-ring between the base pedestal and the box cover for hermetically sealing the SMIF box, and may further include a drying agent. A reticle loading system is also described, including an SMIF box mentioned above and a hermetic SMIF box loader.

### BACKGROUND OF THE INVENTION

1. Field of the Invention

The present invention relates to equipment for semiconductor manufacture. More particularly, the present invention relates to a standard mechanical interface (SMIF) box for storing a reticle, a reticle loading system including the SMIF box, and an SMIF box loader for loading a reticle.

2. Description of the Related Art

Lithography is one of the most important techniques in semiconductor manufacture, while the performance of a lithography process depends largely on the quality of the photomask (reticle) used in the exposure step. Therefore, protecting the reticle from contamination is always an important issue. Referring to FIG. 1, a reticle 100 can be protected from contamination by a transparent pellicle 120, which is usually a thin polymer membrane supported by a pellicle frame 110 fixed on the pattern side of the reticle 100. The exposure light 140 is incident from the other side of the reticle 100 in the exposure step. The pellicle frame 110 is formed with a through hole (not shown) for balancing the pressure, and a filter (not shown) is disposed in the through hole for blocking particles in the environment.

Referring to FIG. 2, a reticle 100 is usually stored in a standard mechanical interface (SMIF) box 200 for operational facility. The SMIF box 200 includes a base pedestal 220 for holding the reticle 100 and a box cover 210. The box cover 210 is illustrated in FIG. 4 in a bottom view, having a circular groove 212 near the edges thereof and four cavities 214 at the four inner corners of the circular groove 212. Referring to FIG. 3, when the reticle 100 is to be used in an exposure process, the SMIF box 200 is placed on a SMIF box loader 300, which separates the base pedestal 220 from the box cover 210 and takes in the base pedestal 220 with the reticle 100 thereon. Then, the reticle 100 is transferred from the SMIF box loader 300 to an exposure optical system (not shown) that is usually filled with inert gas for preventing contamination.

However, since the SMIF box and the SMIF box loader used currently are not hermetic and the filter on the pellicle frame cannot block gas molecules, the ambient gases can easily diffuse to the inner surface of the reticle. Because a reticle is usually washed with sulfuric acid after patterns are formed thereon, the sulfuric acid remaining on the reticle readily reacts with the ammonia gas and water vapor among the ambient gases to form ammonium sulfate crystals. The ammonium sulfate crystals will interfere with the incident light in the exposure process to reduce the yield of wafer.

### SUMMARY OF THE INVENTION

In view of the foregoing, this invention provides a SMIF box for storing a reticle that is capable of preventing access of ammonia and water vapor to the reticle.

This invention also provides a reticle loading system that is capable of preventing access of ammonia and water vapor to the reticle.

This invention further provides a SMIF box loader for loading a reticle that is capable of preventing access of ammonia and water vapor to the reticle.

The SMIF box for storing a reticle of this invention includes a base pedestal for holding the reticle and a box cover fitting with the base pedestal. The box cover includes an O-ring between the base pedestal and the box cover for hermetically sealing the SMIF box, and may further contain a drying agent.

The reticle loading system of this invention includes an SMIF box for storing a reticle and a hermetic SMIF box loader. The SMIF box includes a base pedestal for holding the reticle and a box cover fitting with the base pedestal. The hermetic SMIF box loader is for separating the base pedestal from the box cover and taking in the base pedestal with the reticle thereon for further processing. The box cover of the SMIF box may include an O-ring between the base pedestal and the box cover for hermetically sealing the SMIF box, and may further contain a drying agent.

The SMIF box loader for loading a reticle of this invention includes a hermetic body for loading the reticle, and an inert gas inlet and an air outlet on the hermetic body. The inert gas inlet may be a nitrogen gas inlet.

Since the box cover of the SMIF box for storing a reticle of this invention is disposed with an O-ring, the ammonia gas and water vapor in the environment cannot diffuse into the SMIF box. Meanwhile, by including a drying agent in the box cover to adsorb water vapor, the reaction of sulfuric acid with the ammonia gas in the SMIF box is inhibited. Moreover, by drawing air out of the hermetic body and introducing inert gas into the same, the concentrations of ammonia and water vapor in the SMIF box loader of this invention can be greatly reduced. Therefore, formation of ammonium sulfate crystals is prevented on the surface of the reticle.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 schematically illustrates a cross-sectional view of a reticle with a pellicle thereon in the prior art.

FIG. 2 schematically illustrates a SMIF box with a reticle therein in the prior art.

FIG. 3 schematically illustrates a SMIF box loader together with a separated SMIF box in the prior art.

FIG. 4 schematically illustrates the bottom view of the box cover of a SMIF box for storing a reticle in the prior art.

FIG. 5 schematically illustrates the bottom view of the box cover of a SMIF box for storing a reticle according to a preferred embodiment of this invention.

FIG. 6 schematically illustrates a SMIF box loader together with a separated SMIF box according to the preferred embodiment of this invention.

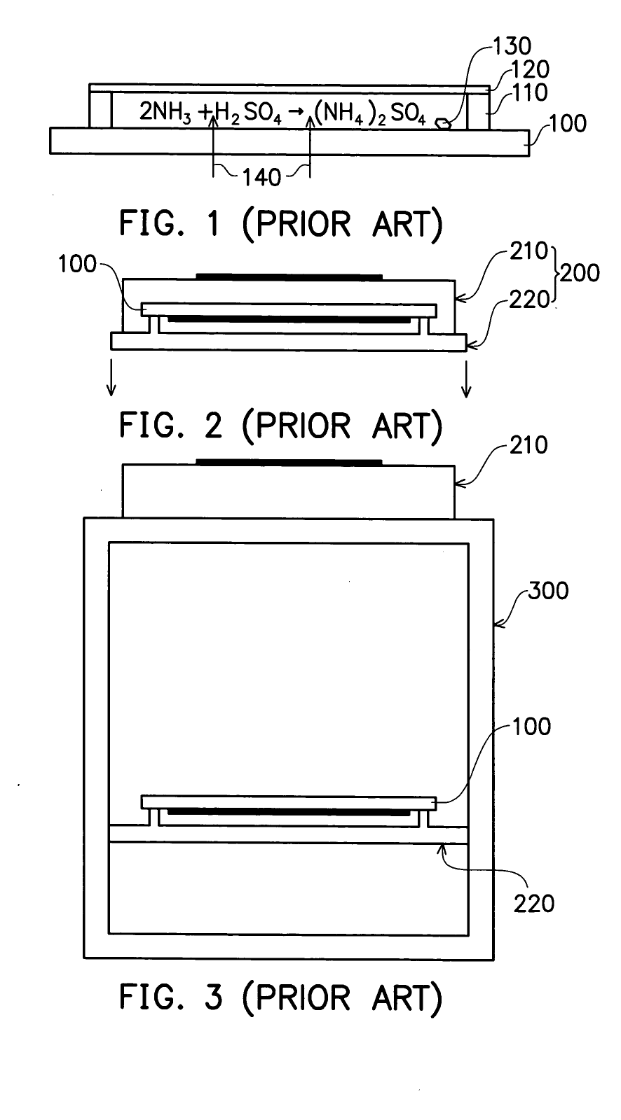

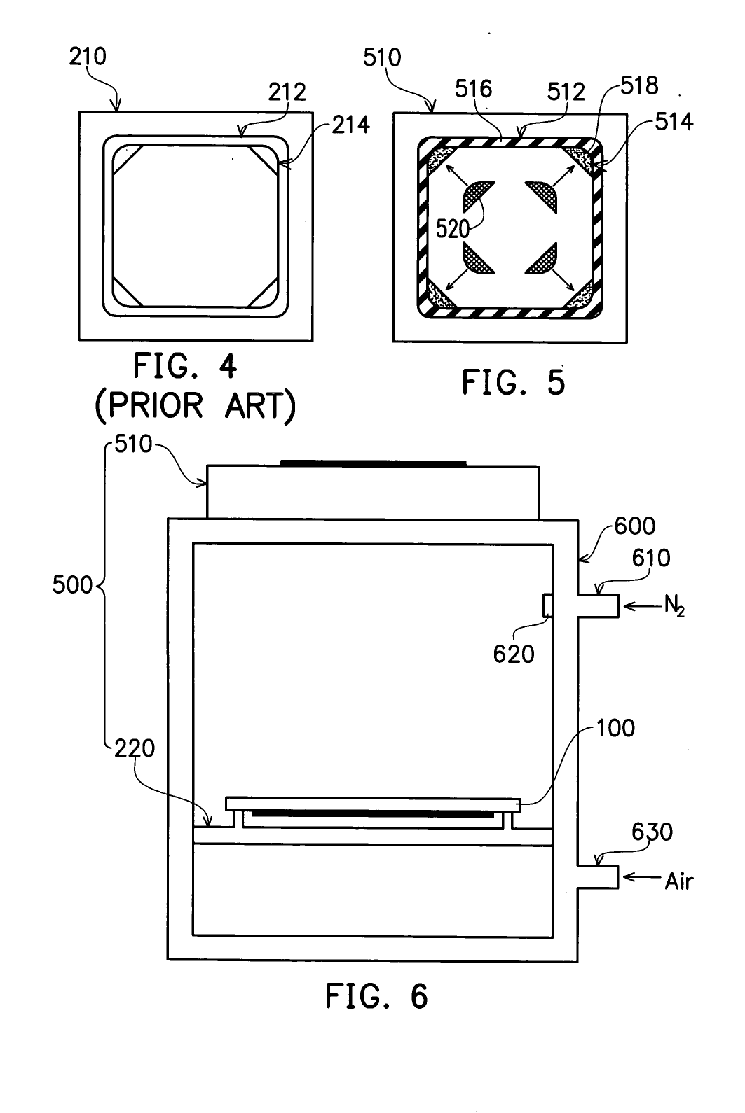

### DESCRIPTION OF THE PREFERRED EMBODIMENTS

FIG. 5 schematically illustrates the bottom view of the box cover of a SMIF box for storing a reticle according to the preferred embodiment of this invention.

Referring to FIG. 5, the box cover 510 has a circular groove 512 near the edges thereof, which has an approximately rectangular shape since the box cover 510 is rectangular. The circular groove 512 is formed at the side of the box cover 510 facing the base pedestal of the SMIF box for holding an O-ring 516, and the width of the circular groove 512 is preferably uniform to fit with the O-ring 516. The O-ring 516 may be made from acrylonitrile-butadiene rubber (NBR), silicone rubber (SI) or fluorine rubber (FPM), etc. When the box cover is joined with the base pedestal of the SMIF box, the O-ring 516 is pressed onto the surface of the base pedestal to hermetically seal the SMIF box, so that the ammonia gas and water vapor in the environment cannot diffuse into the SMIF box. Consequently, the surface of the reticle does not contact with ammonia gas and water vapor, and ammonium sulfate crystals will not be formed on the reticle.

Referring to FIG. 5 again, the box cover 510 further has four cavities 514 at the four inner corners of the circular groove 512. Each cavity 514 is filled with a drying agent 518, so as to adsorb the water vapor in the SMIF box. Examples of the drying agent 518 include sodium sulfate, magnesium sulfate, calcium chloride and magnesium chloride, etc. Since water vapor is required in the reaction of ammonia and sulfuric acid, formation of ammonium sulfate crystals on the surface of the reticle can be further prevented. In addition, when the drying agent 518 is powdery or granular, each cavity 514 is sealed with a filter net 520 that allows passage of water vapor but does not allow grains of the drying agent 108 to pass, so that the drying agent 108 can be retained in the cavities 514.

FIG. 6 schematically illustrates a SMIF box loader together with a separated SMIF box according to the preferred embodiment of this invention. The SMIF box loader and the SMIF box together constitute a reticle loading system of this invention.

Referring to FIG. 6, The SMIF box loader includes a hermetic body 600 for loading the reticle 100, and an inert gas inlet 610 and an air outlet 630 on the hermetic body 600. The inert gas inlet 610 may be a nitrogen gas inlet, and a filter 620 is preferably disposed at the inert gas inlet 610 for removing particles in the inert gas supplied. By drawing air through the air outlet 630 and introducing inert gas through the inert gas inlet 610, the hermetic body 600 can be filled with inert gas. When the reticle 100 is to be used in an exposure process, the SMIF box 500 is placed on the hermetic body 600, which then separates the base pedestal 220 from the box cover 510 and takes in the base pedestal 220 with the reticle 100 thereon. The air in the hermetic body 600 is then drawn out through the air outlet 630, and an inert gas is simultaneously introduced into the hermetic body 600 through the inert gas inlet 610 so that the hermetic body 600 is filled with the inert gas. Therefore, the surface of the reticle 100 will not contact with ammonia gas and water vapor, and ammonium sulfate crystals will not be formed on the reticle 100.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

1. A standard mechanical interface (SMIF) box for storing a reticle, comprising:
a base pedestal for holding the reticle; and
a box cover fitting with the base pedestal including an O-ring between the base pedestal and the box cover for hermetically sealing the SMIF box.

2. The SMIF box of claim 1, wherein the box cover further includes a drying agent.

3. The SMIF box of claim 2, wherein the box cover further includes a filter net for retaining the drying agent.

4. The SMIF box of claim 1, wherein the box cover has a circular groove near edges of the box cover for holding the O-ring.

5. The SMIF box of claim 4, wherein
the box cover further includes a drying agent;
the circular groove has a approximately rectangular shape; and
the box cover further has four cavities at four inner corners of the circular groove for holding the drying agent.

6. The SMIF box of claim 5, wherein the box cover further includes a filter net that seals each cavity for retaining the drying agent.

7. A reticle loading system, comprising:
an SMIF box for storing a reticle, comprising a base pedestal for holding the reticle and a box cover fitting with the base pedestal, wherein the box cover has a circular groove at inner surface thereof and an O-ring is placed in the circular groove for hermetically sealing the box cover and the base pedestal; and
a hermetic SMIF box loader for separating the base pedestal from the box cover and taking in the base pedestal with the reticle thereon.

8. (canceled)

9. The reticle loading system of claim 7, wherein the box cover further includes a drying agent.

10. The reticle loading system of claim 9, wherein the box cover further includes a filter net for retaining the drying agent.

11. The reticle loading system of claim 7, wherein the box cover has a circular groove near edges of the box cover for holding the O-ring.

12. The reticle loading system of claim 11, wherein
the box cover further includes a drying agent;
the circular groove has a approximately rectangular shape; and
the box cover further has four cavities at four inner corners of the circular groove for holding the drying agent.

13. The reticle loading system of claim 12, wherein the box cover further includes a filter net that seals each cavity for retaining the drying agent.

14. The reticle loading system of claim 7, wherein the hermetic SMIF box loader has an inert gas inlet and an air outlet thereon.

15. The reticle loading system of claim 14, wherein the inert gas inlet comprises a nitrogen gas inlet.

16. An SMIF box loader for loading a reticle from an SMIF box storing the reticle, comprising:
a hermetic body for loading the reticle from the SMIF box; and
an inert gas inlet and an air outlet on the hermetic body.

17. The SMIF box loader of claim 16, wherein the inert gas inlet comprises a nitrogen gas inlet.
